(19) United States
(12) Patent Application Publication
(10) Pub. No.: US 2025/0299603 A1
(43) Pub. Date: Sep. 25, 2025

(54) Fuel System Demonstrator Device

(71) Applicant: Illinois Tool Works Inc., Glenview, IL (US)

(72) Inventor: Anthony M. Millunzi, Katy, TX (US)

(21) Appl. No.: 18/939,192

(22) Filed: Nov. 6, 2024

Related U.S. Application Data
(60) Provisional application No. 63/569,634, filed on Mar. 25, 2024.

(51) Int. Cl. G09B 25/02

(52) U.S. Cl. CPC G09B 25/02

(57) ABSTRACT

Disclosed is a fuel system demonstrator device having a housing assembly that defines a demonstrator cavity, a partition dividing the demonstrator cavity into a first nozzle chamber and a second nozzle chamber, a plurality of spray nozzles, and a pump system. The plurality of spray nozzles includes a first spray nozzle positioned in said first nozzle chamber and a second spray nozzle positioned in said second nozzle chamber. The pump system is operatively connected to said plurality of spray nozzles to draw liquid from a liquid reservoir and to provide liquid to said first spray nozzle and said second spray nozzle. The first spray nozzle creates a first spray pattern, and the second spray nozzle creates a second spray pattern that is different from the first spray pattern.

### RELATED APPLICATION

The present application claims priority to U.S. Provisional Patent Application No. 63/569,634, filed Mar. 25, 2024, and entitled “Fuel System Demonstrator Device,” which is hereby incorporated by reference in its entirety.

### BACKGROUND

Engine performance is influenced by various factors ranging from carbon deposits and corrosion to heat and friction. Among these, the fuel system plays a crucial role in ensuring the engine receives the necessary fuel to operate. While carbon build-up typically occurs gradually, it can form deposits in as little as a month in a new car, resulting in decreased combustion efficiency. If left unaddressed, this build-up can severely restrict the system, leading to diminished performance in older vehicles compared to when they were new.

Fuel injectors, for instance, can accumulate grime, dirt, and soot, leading to an imbalance in the air-fuel mixture. Dirty injector nozzles may distort or deflect the spray pattern, creating lean spots in the combustion chamber that can cause misfires, pre-ignition, or detonation. Consequently, this can result in rough idling and inconsistent gas mileage over time. Using a fuel system cleaner as a preventative measure can help inhibit the formation of these deposits, thereby maintaining optimal performance. Such cleaners effectively remove harmful carbon buildup from the fuel system, preserving the car's performance and engine health over time. However, many consumers (e.g., motorists) struggle to comprehend the internal workings of their vehicle's engine, often opting to ignore maintenance until issues arise. Therefore, it can be tempting just to ignore any type of maintenance unless something goes wrong.

In view of the foregoing, a need exists for a fuel system demonstrator device to help educate consumers by enabling them to visually observe what happens when a fuel injector becomes dirty inside the engine. Consumer education will increase the likelihood they perform preventative maintenance of their vehicles.

### SUMMARY

The present disclosure relates generally to a fuel system demonstrator device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a perspective view of a fuel system demonstrator device in accordance with an aspect of this disclosure.

FIGS. 1b through 1d illustrate, respectively, front, rear, and side elevation views of the fuel system demonstrator device of FIG. 1a.

FIG. 2a illustrates a diagram of an electric pump system for the fuel system demonstrator device in accordance with a first aspect of this disclosure.

FIG. 2b illustrates a diagram of an electric pump system for the fuel system demonstrator device in accordance with a second aspect of this disclosure.

FIG. 2c illustrates a diagram of an electric pump system for the fuel system demonstrator device in accordance with a third aspect of this disclosure.

FIG. 3a illustrates a diagram of a manual pump system for the fuel system demonstrator device in accordance with an aspect of this disclosure.

FIG. 3b illustrates a diagram of an example piston pump.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” “upper,” “lower,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The term “processor” as used herein means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing.

Disclosed is a fuel system demonstrator device. In one example, a fuel system demonstrator device comprises: a housing assembly defining a demonstrator cavity; a partition dividing said demonstrator cavity into a first nozzle chamber and a second nozzle chamber; a plurality of spray nozzles, the plurality of spray nozzles comprises a first spray nozzle positioned in said first nozzle chamber and a second spray nozzle positioned in said second nozzle chamber; and a pump system operatively connected to said plurality of spray nozzles and configured to draw liquid from a liquid reservoir and to provide liquid to said first spray nozzle and said second spray nozzle, wherein the first spray nozzle is configured to create a first spray pattern, and wherein the second spray nozzle is configured to create a second spray pattern that is different from the first spray pattern.

In another example, a fuel system demonstrator device comprises: a housing assembly defining a demonstrator cavity; a plurality of spray nozzles, the plurality of spray nozzles comprises a first spray nozzle and a second spray nozzle; and a pump system operatively connected to said plurality of spray nozzles and configured to draw liquid from a liquid reservoir and to provide liquid to said first spray nozzle and said second spray nozzle, wherein the first spray nozzle is configured to create a first spray pattern, and wherein the second spray nozzle is configured to create a second spray pattern that is different from the first spray pattern.

In yet another example, a fuel system demonstrator device comprises: a housing assembly defining a demonstrator cavity; a plurality of spray nozzles, the plurality of spray nozzles comprises a first spray nozzle and a second spray nozzle; and a pump system operatively connected to said plurality of spray nozzles and configured to draw liquid from a liquid reservoir and to provide liquid to said first spray nozzle and said second spray nozzle, wherein the pump system comprises a first piston pump configured to draw liquid from the liquid reservoir and to provide liquid to the first spray nozzle to create a first spray pattern, and a second piston pump configured to draw liquid from the liquid reservoir and to provide liquid to the second spray nozzle to create a second spray pattern that is different from the first spray pattern.

In some examples, the pump system comprises a first pump configured to draw liquid from the liquid reservoir and to provide liquid to the first spray nozzle, and a second pump configured to draw liquid from the liquid reservoir and to provide liquid to the second spray nozzle.

In some examples, the first pump and the second pump are independently controllable.

In some examples, each of the first pump and the second pump is an electric pump or a piston pump.

In some examples, the piston pump comprises a positive displacement pump shaft and a pump chamber.

In some examples, the piston pump comprises a check valve positioned at each of an inlet and an outlet to the pump chamber.

In some examples, the first spray pattern is a disturbed spray pattern, and the second spray pattern is an even spray pattern.

In some examples, the housing assembly includes a first button associated with the first spray nozzle and a second button associated with a second spray nozzle.

In some examples, each of the first nozzle chamber and the second nozzle chamber comprises a splash plate.

In some examples, the housing assembly comprises one or more floor plates configured to collect and guide liquid from the plurality of spray nozzles back to the liquid reservoir via one or more liquid openings.

In some examples, the housing assembly comprises a base, a demonstration chamber, and a cover, and the demonstration chamber is transparent and defines the demonstrator cavity.

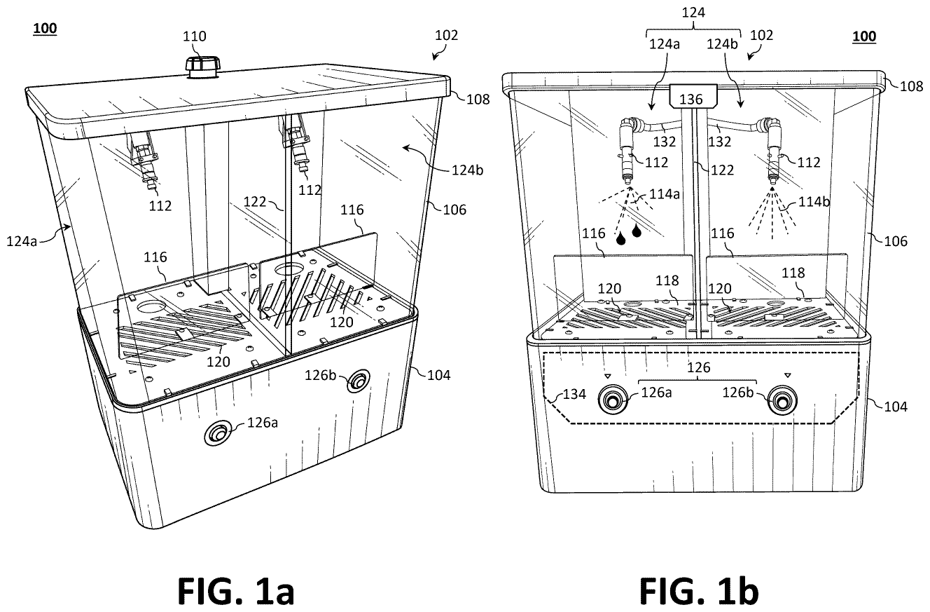

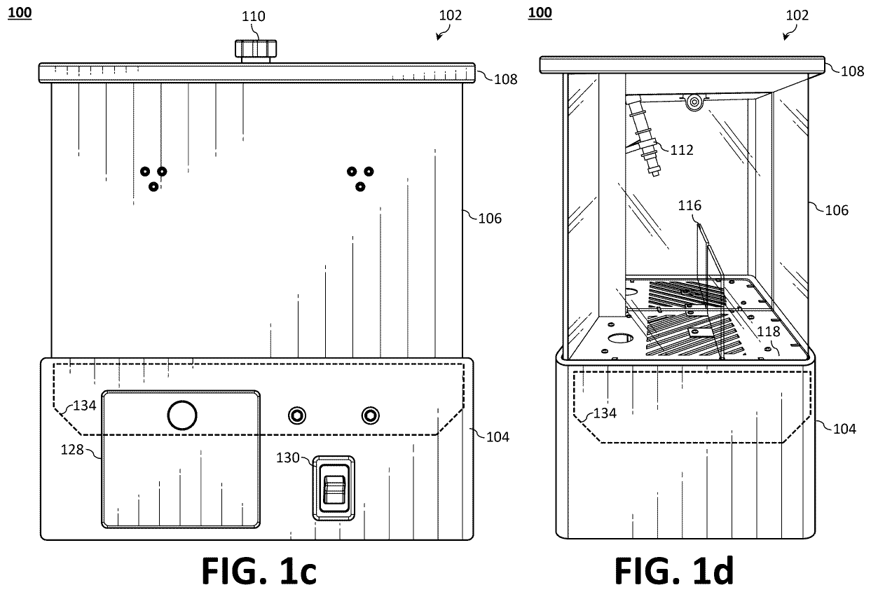

FIG. 1a illustrates a perspective view of a fuel system demonstrator device 100 in accordance with an aspect of this disclosure, while FIGS. 1b through 1d illustrate, respectively, front, rear, and side elevation views of the fuel system demonstrator device 100. As illustrated, the fuel system demonstrator device 100 generally comprises a housing assembly 102 that defines a demonstrator cavity 124 with a set of spray nozzles 112 positioned therein. In this example, each of the set of spray nozzles 112 is configured to resemble a fuel injector; however, an actual fuel injector can be used for each spray nozzle 112 where sufficient pressure is created in the fuel system demonstrator device 100 to pass liquid through fuel injectors.

The illustrated housing assembly 102 comprises a base 104, a demonstration chamber 106, and a cover 108. The housing assembly 102, or components thereof, may be fabricated from a plastic material, such as acrylonitrile butadiene styrene (ABS), polypropylene (PP), polyethylene terephthalate (PET), high-density polyethylene (HDPE), polyvinyl chloride (PVC), low-density polyethylene (LDPE), polystyrene (PS), or a combination thereof. In some examples, one or more components are transparent (e.g., clear, translucent, etc.). The housing assembly 102 generally houses the various function components of the fuel system demonstrator device 100.

An advantage of the fuel system demonstrator device 100 is the ability to visually show consumers, in a retail/tradeshow setting, how carbon and varnish buildup on a spray nozzle 112 affects the spray patterns of the spray nozzles 112.

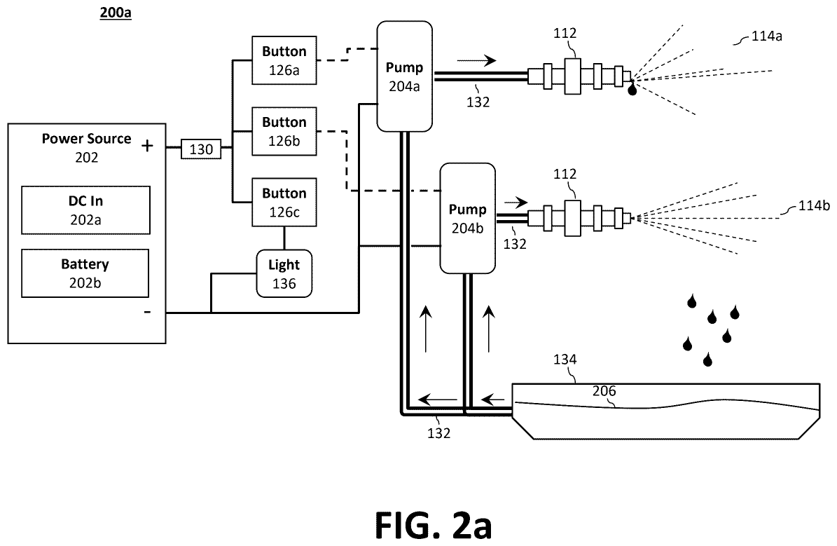

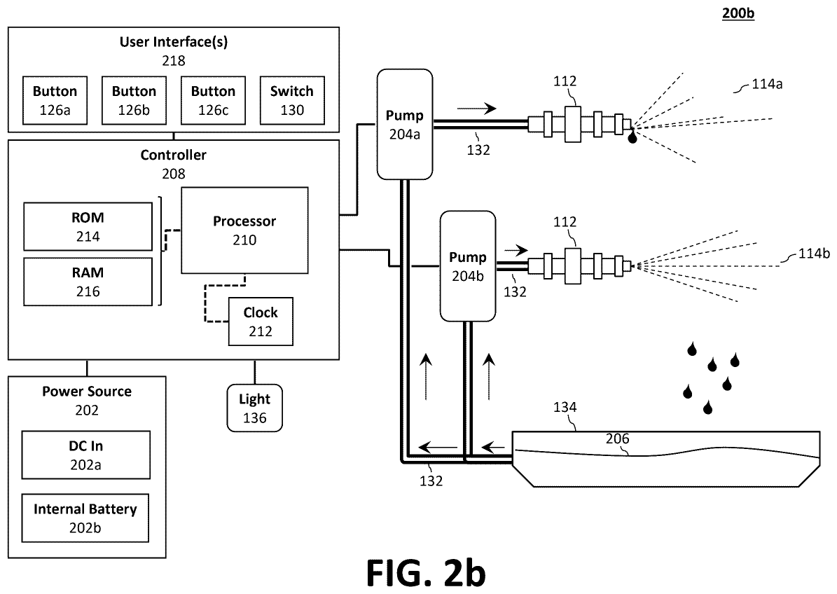

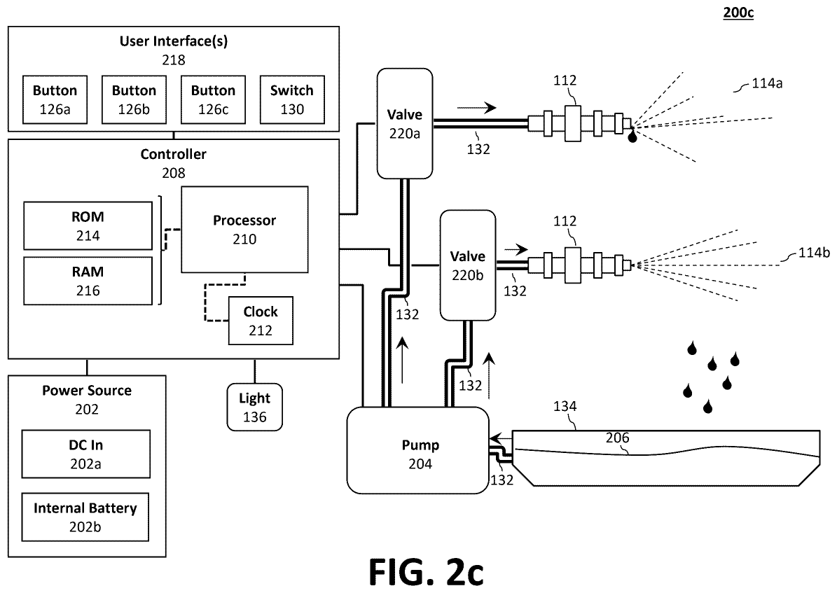

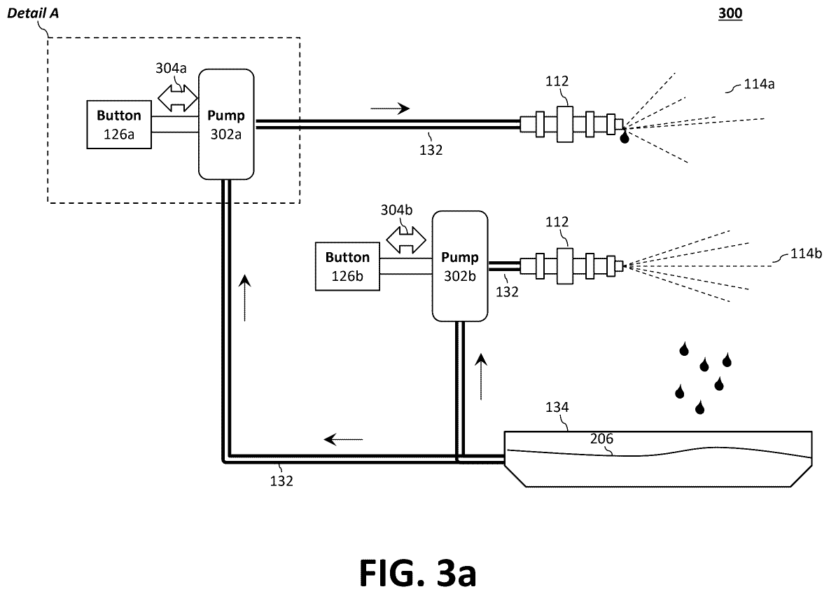

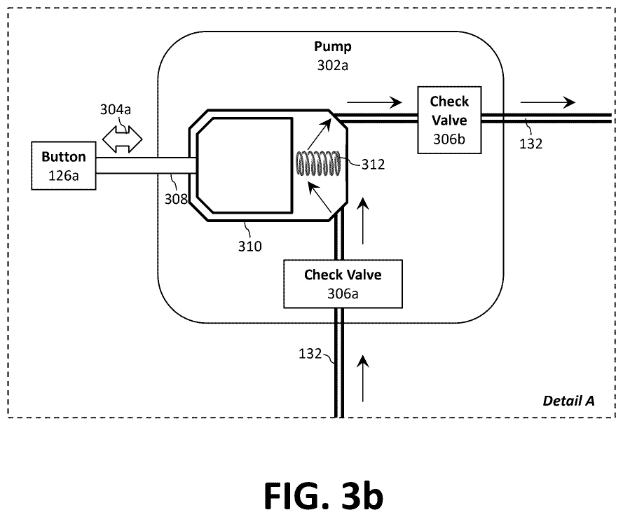

As illustrated, two or more demonstration spray nozzles 112 are placed inside the demonstration chamber 106. Each spray nozzle 112 is operated via a dedicated button 126a, 126b that is configured to draw liquid from a liquid reservoir 134 via fluid conduits 132 and one or more pumps and to direct the liquid through spray nozzle 112. As will be discussed in connection with FIGS. 2a through 2c and FIG. 3, liquid can be driven through spray nozzle 112 via an electric pump system or a manual pump system. For example, the liquid can be moved by a battery-operated pump or a non-powered pump that relies on pressure generated via a manual button press (e.g., a piston). In some examples, the fuel system demonstrator device 100 includes a light 136 to illuminate the demonstrator cavity 124 and/or the set of spray nozzles 112.

The first spray nozzle 112 is configured to create a first spray pattern 114a, and the second spray nozzle 112 is configured to create a second spray pattern 114b that is different from the first spray pattern 114a. For example, the first spray nozzle 112 is configured to create a first spray pattern 114a to demonstrate a disturbed spray pattern of a dirty spray nozzle 112, while the second spray nozzle 112 is configured to create a second spray pattern 114b to demonstrate an even spray pattern to accurately show how a properly functioning spray nozzle 112 would spray. To that end, the nozzles of the first spray nozzle 112 and the second spray nozzle 112 can be shaped to form a desired spray profile. The liquid from the spray nozzles 112 is returned to a liquid reservoir 134 such that it can be reused and recirculated. The liquid may be, for example, water that is dyed brown or an amber color to resemble fuel. One or more additives may be added to the liquid to mitigate risk to health associated with standing water. For example, an antibacterial agent may be added to the liquid.

The illustrated base 104 defines a base cavity configured to house and visually obscure the various function components of the fuel system demonstrator device 100, such as liquid pumps, power supplies, liquid reservoir 134, electronics, tubing, and the like. To that end, the base 104 can be fabricated to form a material that is not transparent. The base 104 further supports the demonstration chamber 106.

The base 104 can include one or more user interfaces 126, such as a first button 126a associated with a first spray nozzle 112, a second button 126b associated with a second spray nozzle 112, a third button to control the light 136, and a power switch 130 to control the overall power supply. The base 104 can further provide a removable access panel 128 to permit access to the base cavity. For example, to perform maintenance or repairs.

The demonstration chamber 106 can be fabricated from a material that is transparent to enable consumers to view the set of spray nozzles 112 positioned therein. The demonstration chamber 106 can include a partition 122 configured to divide the demonstrator cavity 124 into two nozzle chambers 124a, 124b. As illustrated, the first nozzle chamber 124a and the second nozzle chamber 124b are substantially the same size but mirrored. A first spray nozzle 112 is positioned in the first nozzle chamber 124a and second spray nozzle 112 is positioned in the second nozzle chamber 124b.

Each of the first nozzle chamber 124a and the second nozzle chamber 124b includes a floor plate 118 that collects and guides liquid from the spray nozzles 112 to the liquid reservoir 134 via one or more liquid openings 120 (e.g., slots, holes, etc.). Each of the first nozzle chamber 124a and the second nozzle chamber 124b can include a splash plate 116 to help direct spray from spray nozzle 112 away from the outer walls of the demonstrator cavity 124, thus mitigating visual obstruction of the demonstrator cavity 124.

The cover 108 can be removably coupled to the demonstration chamber 106 to enable access to the demonstrator cavity 124. For example, to perform maintenance or repairs. To that end, a fastener 110 (e.g., a threaded knob) is provided that can be loosened or removed to enable removal of the cover 108.

FIG. 2a illustrates a diagram of an electric pump system 200a for the fuel system demonstrator device in accordance with a first aspect of this disclosure. In this example, the electric pump system 200a in an analog system that controls power transfer between a power source 202 and a set of electric pumps 204a, 204b and light 136 via one or more electric switches (e.g., buttons 126a, 126b, 126c, power switch 130, etc.).

The power source 202 can provide, for example, between 12 volts and 20 volts to power the set of electric pumps 204a, 204b and light 136. The power source 202 may include, for example, a DC input 202a (e.g., a wired DC power supply) and/or a battery 202b (e.g., a rechargeable lithium battery). In some examples, the battery 202b can be removably coupled to the electric pump system 200a via, for example, a dock. In some examples, the battery 202b is a power tool battery pack, for example, an 18v or 20v power tool battery pack.

As illustrated, the set of electric pumps 204a, 204b are configured to draw liquid 206 from the liquid reservoir 134 and through the spray nozzles 112 via fluid conduits 132. The fluid conduits 132 (e.g., tubing, hoses, etc.) may be rigid, flexible, or a combination thereof.

The first and second electric pumps 204a, 204b can be controlled independently. In this example, the first electric pump 204a is connected to the power source 202 via the first button 126a, while the second electric pump 204b is connected to the power source 202 via the second button 126b. Pressing the first button 126a activates the first electric pump 204a to create the first spray pattern 114a and pressing the second button 126b activates the second electric pump 204b to create the second spray pattern 114b. Each of the first and second buttons 126a, 126b can be, for example, a momentary electric push button that, when pressed completes the circuit, but automatically returns to an open circuit state when the button is released.

The light 136 can be connected to the power source 202 via the third button 126c. Pressing the third button 126c activates the light 136 to illuminate the demonstrator cavity 124. The third button 126c can be, for example, a momentary electric push button, a push-on, push-off button, etc. Finally, the power switch 130 can be used to turn power on or off to the fuel system demonstrator device 100. The power switch 130 effectively connects and disconnects the power source to the various electric components. While certain button and switch examples are mentioned, various types of electric switches and buttons can be used to control the various components of the fuel system demonstrator device 100, including, for example, toggle switches, push buttons, rocker switches, slide switches, rotary switches, etc.

FIG. 2b illustrates a diagram of an electric pump system 200b for the fuel system demonstrator device in accordance with a second aspect of this disclosure. In this example, the electric pump system 200b in a digital system that controls power transfer between a power source 202 and a set of electric pumps 204a, 204b and light 136 via a controller 208 and one or more electric switches (e.g., buttons 126a, 126b, 126c, power switch 130, etc.).

The illustrated controller 208 is coupled to the set of electric pumps 204a, 204b, the power source 202, a light 136, and one or more user interfaces 218. The one or more user interfaces 218 serve as control inputs to the controller 208 and include, for example, a first button 126a associated with a first spray nozzle 112, a second button 126b associated with a second spray nozzle 112, a third button to control the light 136, and a power switch 130 to control the overall power supply. In one example, each of the one or more user interfaces 218 is a momentary electric push button; though various types of electric switches and buttons can be used to control the various components of the fuel system demonstrator device 100. The power source 202 is the same as described in connection with the electric pump system 200a of FIG. 2a.

The controller 208 may comprise one or more processors 210 (e.g., a microprocessor, a central processing unit (CPU), etc.) to control the various operations of the fuel system demonstrator device 100. The one or more processors 210 may be operatively coupled to one or more memory devices, such as a read-only memory (ROM) 214 for receiving one or more instruction sets, a random access memory (RAM) 216 having a plurality of buffers for temporarily storing and retrieving information, and to an internal data storage device (e.g., a hard drive, such a solid state drive, or other non-volatile data storage device, such as flash memory). A clock 212 is also coupled to the processor 210 for providing clock or timing signals or pulses thereto. While a single processor 210 is illustrated, a plurality of processors 210 may be used to operate the fuel system demonstrator device 100.

While FIGS. 2a and 2b illustrate and describe electric pump systems 200a, 200b with two separate pumps 204a, 204b, it is contemplated that utilizing a single pump 204 could offer cost savings. This configuration would involve directing fluid to the first and second spray nozzles 112 using one or more valves, which could be controlled electrically, for instance, via an actuator.

FIG. 2c presents a diagram of an electric pump system 200c designed for the fuel system demonstrator device 100, aligning with a third aspect of this disclosure. In this instance, the electric pump system 200c employs a single pump 204 to pressurize the fluid conduits 132. During operation, the pump 204 maintains the pressure within the fluid conduits 132 within a predefined range. For instance, the pump 204 would shut off when the pressure peaks at a maximum value and would activate when the pressure decreases to a minimum value. The buttons 126a and 126b are configured to control their respective actuator-controlled valves 220a, 220b to regulate fluid flow to the injectors 112. While the electric pump system 200c of FIG. 2c comprises a controller 208 (as discussed in connection with FIG. 2b), a setup utilizing a single pump 204 and a set of valves 220a, 220b could be adapted to an analog system that manages power transfer between a power source 202, valves 220a, 220b, and light 136 via one or more electric switches (e.g., buttons 126a, 126b, 126c, power switch 130, etc.) without a controller 208 (as discussed in connection with the electric pump system 200a of FIG. 2a).

FIG. 3a illustrates a diagram of a manual pump system 300 for the fuel system demonstrator device 100 in accordance with an aspect of this disclosure, while FIG. 3b illustrates a diagram of an example piston pump 302a. In this example, the fuel system demonstrator device 100 does not require electric power and, as such, the various electronic components are omitted.

A manual pump system 300 offers certain advantages over the electric pump systems 200a, 200b including, for example, lower manufacturing cost, more environmentally-friendly, no reliance on power outlets or battery charging, etc. The illustrated manual pump system 300 comprises a set of piston pumps 302a, 302b, each configured to draw liquid 206 from the liquid reservoir 134 and through a respective one of the set of spray nozzles 112 via fluid conduits 132. The fluid conduits 132 (e.g., tubing, hoses, etc.) may be rigid, flexible, or a combination thereof.

With reference to FIG. 3b, each of the set of piston pumps 302a, 302b comprises a positive displacement pump shaft 308 and a pump chamber 310. The positive displacement pump shaft 308 is configured to move linearly in and relative to the pump chamber 310 as indicated by arrows 304a, 304b. The button 126a, 126b is coupled to and configured to actuate the positive displacement pump shaft 308 as indicated by arrows 304a, 304b. In this example, a spring 312 positioned in the pump chamber 310 is configured to bias the displacement pump shaft 308 into a default position (e.g., when the button 126a, 126b is released). With the aid of two check valves 306a, 306b (e.g., one-way valves), fluid is drawn into a pump chamber 310 of the pump 302a from a liquid reservoir 134, then forced out the spray nozzles 112 upon depressing the button 126a, 126b. In the illustrated example, a first check valve 306a is positioned at the inlet to the pump chamber 310 and a second check valve 306b is positioned at the outlet of the pump chamber 310. A design consideration is the volume of liquid 206 that can be effectively moved per press of the button 126a, 126b. Increasing pump volume (e.g., the size of the pump chamber 310) would require more user effort to push the fluid out.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A fuel system demonstrator device (100) comprising:
a housing assembly (102) defining a demonstrator cavity (124);
a partition dividing said demonstrator cavity (124) into a first nozzle chamber (124a) and a second nozzle chamber (124b);
a plurality of spray nozzles (112), the plurality of spray nozzles (112) comprising a first spray nozzle (112) positioned in said first nozzle chamber (124a) and a second spray nozzle (112) positioned in said second nozzle chambers (124b); and
a pump system (200, 300) operatively connected to said plurality of spray nozzles and configured to draw liquid from a liquid reservoir and to provide liquid to said first spray nozzle (112) and said second spray nozzle (112),
wherein the first spray nozzle (112) is configured to create a first spray pattern (114a), and
wherein the second spray nozzle (112) is configured to create a second spray pattern (114b) that is different from the first spray pattern (114a).

2. The fuel system demonstrator device (100) of claim 1, wherein the pump system (200, 300) comprises a first pump (204a, 302a) configured to draw liquid from the liquid reservoir and to provide liquid to the first spray nozzle (112), and a second pump (204b, 302b) configured to draw liquid from the liquid reservoir and to provide liquid to the second spray nozzle (112).

3. The fuel system demonstrator device (100) of claim 2, wherein the first pump (204a, 302a) and the second pump (204b, 302b) are independently controllable.

4. The fuel system demonstrator device (100) of claim 2, wherein each of the first pump (204a, 302a) and the second pump (204b, 302b) is an electric pump.

5. The fuel system demonstrator device (100) of claim 2, wherein each of the first pump (204a, 302a) and the second pump (204b, 302b) is a piston pump.

6. The fuel system demonstrator device (100) of claim 5, wherein the piston pump comprises a positive displacement pump shaft (308) and a pump chamber (310).

7. The fuel system demonstrator device (100) of claim 6, wherein the piston pump comprises a check valve (306a, 306b) positioned at each of an inlet and an outlet to the pump chamber (310).

8. The fuel system demonstrator device (100) of claim 6, wherein the first spray pattern (114a) is a disturbed spray pattern and the second spray pattern (114b) is an even spray pattern.

9. The fuel system demonstrator device (100) of claim 1, wherein the housing assembly (102) includes a first button (126a) associated with the first spray nozzle (112) and a second button (126b) associated with a second spray nozzle (112).

10. The fuel system demonstrator device (100) of claim 1, wherein each of the first nozzle chamber (124a) and the second nozzle chamber (124b) comprises a splash plate (116).

11. The fuel system demonstrator device (100) of claim 1, wherein the housing assembly (102) comprises one or more floor plates (118) configured to collect and guide liquid from the plurality of spray nozzles (112) back to the liquid reservoir (134) via one or more liquid openings (120).

12. The fuel system demonstrator device (100) of claim 1,
wherein the housing assembly (102) comprises a base (104), a demonstration chamber (106), and a cover (108), and
wherein the demonstration chamber (106) is transparent and defines the demonstrator cavity (124).

13. A fuel system demonstrator device (100) comprising:
a housing assembly (102) defining a demonstrator cavity (124);
a plurality of spray nozzles (112), the plurality of spray nozzles (112) comprising a first spray nozzle (112) and a second spray nozzle (112); and
a pump system (200, 300) operatively connected to said plurality of spray nozzles and configured to draw liquid from a liquid reservoir and to provide liquid to said first spray nozzle (112) and said second spray nozzle (112),
wherein the first spray nozzle (112) is configured to create a first spray pattern (114a), and
wherein the second spray nozzle (112) is configured to create a second spray pattern (114b) that is different from the first spray pattern (114a).

14. The fuel system demonstrator device (100) of claim 13, wherein the pump system (200, 300) comprises a first pump (204a, 302a) configured to draw liquid from the liquid reservoir and to provide liquid to the first spray nozzle (112), and a second pump (204b, 302b) configured to draw liquid from the liquid reservoir and to provide liquid to the second spray nozzle (112).

15. The fuel system demonstrator device (100) of claim 14, wherein the first pump (204a, 302a) and the second pump (204b, 302b) are independently controllable.

16. The fuel system demonstrator device (100) of claim 14, wherein each of the first pump (204a, 302a) and the second pump (204b, 302b) is an electric pump.

17. The fuel system demonstrator device (100) of claim 14, wherein each of the first pump (204a, 302a) and the second pump (204b, 302b) is a piston pump.

18. A fuel system demonstrator device (100) comprising:
a housing assembly (102) defining a demonstrator cavity (124);
a plurality of spray nozzles (112), the plurality of spray nozzles (112) comprising a first spray nozzle (112) and a second spray nozzle (112); and
a pump system (200, 300) operatively connected to said plurality of spray nozzles and configured to draw liquid from a liquid reservoir and to provide liquid to said first spray nozzle (112) and said second spray nozzle (112),
wherein the pump system (200, 300) comprises a first piston pump (204a, 302a) configured to draw liquid from the liquid reservoir and to provide liquid to the first spray nozzle (112) to create a first spray pattern (114a), and a second piston pump (204b, 302b) configured to draw liquid from the liquid reservoir and to provide liquid to the second spray nozzle (112) to create a second spray pattern (114b) that is different from the first spray pattern (114a).

19. The fuel system demonstrator device (100) of claim 18, wherein the piston pump comprises a positive displacement pump shaft (308), a pump chamber (310), and a check valve (306a, 306b) positioned at each of an inlet and an outlet to the pump chamber (310).

20. The fuel system demonstrator device (100) of claim 18, wherein the first spray pattern (114a) is a disturbed spray pattern and the second spray pattern (114b) is an even spray pattern.
